(19) United States
(12) Patent Application Publication
(10) Pub. No.: US 2006/0266003 A1
(43) Pub. Date: Nov. 30, 2006

(54) Beverage bottling plant for filling bottles with a liquid beverage filling material having a filling machine with a filling control element

(76) Inventors: Roland Topf, Hamburg (DE); Matthias Bestmann, Hamburg (DE)

Correspondence Address: NILS H. LJUNGMAN;NILS H. LJUNGMAN & ASSOCIATES, P.O. BOX 130, GREENSBURG, PA, 15601-0130, US

(21) Appl. No.: 11/370,217

(22) Filed: Mar. 7, 2006

(30) Foreign Application Priority Data
Mar. 8, 2005 (DE) 10 2005 011 659.0

(51) Int. Cl. B65B 3/00; B67C 3/00

(52) U.S. Cl. 53/281; 141/146

(57) ABSTRACT

A beverage bottling plant for filling bottles with a liquid beverage filling material having a filling machine with a filling control element. The abstract of the disclosure is submitted herewith as required by 37 C.F.R. §1.72(b). As stated in 37 C.F.R. §1.72(b): A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims. Therefore, any statements made relating to the abstract are not intended to limit the claims in any manner and should not be interpreted as limiting the claims in any manner.

### BACKGROUND

1. Technical Field

The present application relates to a beverage bottling plant for filling bottles with a liquid beverage filling material having a filling machine with a filling control element.

2. Background Information

A beverage bottling plant for filling bottles with a liquid beverage filling material can possibly comprise a beverage filling machine with a plurality of beverage filling positions, each beverage filling position having a beverage filling device for filling bottles with liquid beverage filling material. The filling devices may have an apparatus designed to introduce a predetermined volume of liquid beverage filling material into the interior of bottles to a substantially predetermined level of liquid beverage filling material. The apparatus designed to introduce a predetermined flow of liquid beverage filling material further comprises an apparatus that is designed to terminate the filling of the beverage bottles upon the liquid beverage filling material reaching the predetermined level in bottles. There may also be provided a conveyer arrangement that is designed to move bottles, for example, from an inspecting machine to the filling machine. Upon filling, a closing station closes the filled bottles. There may further be provided a conveyer arrangement configured to transfer filled bottles from the filling machine to the closing station. Bottles may be labeled in a labeling station, the labeling station having a conveyer arrangement to receive bottles and to output bottles. The closing station and the labeling station may be connected by a corresponding conveyer arrangement.

Control elements or piston drives or piston actuators of this type are described in the prior art and are used in a variety of applications, including but not restricted to filling machines, to effect a controlled opening and closing of the filling valves that are provided at the individual filling stations.

The prior art also describes control elements of this type in a realization in which two pistons that act on a common actuator or on a common piston rod are provided, whereby the cylinder compartments of the piston can each be pressurized individually with the fluid pressure, so that two different lifting movements, for example two lifting movements of different magnitudes, are possible for the actuator.

The prior art also describes manually adjustable stroke limiters that are formed by machine screws with locknuts and are provided to limit and adjust the lifting movements. Instead of said screws, in some cases hand wheels, some of which have adjustment scales, are also used. Another measure of the prior art to adjust the hub movement is the use of washers, which can then be incorporated into the related control element, for example.

In particular in plants or on machines that have a plurality of such control elements, such as filling machines, for example, the adjustment of the stroke limiters is extremely time-consuming.

### OBJECT OR OBJECTS

The object is to indicate a control element that eliminates this disadvantage and, among other things, makes possible an adjustment of the at least one stroke limiter by means of an external control mechanism, for example a central machine control system.

### SUMMARY

To accomplish this task, the present application teaches a control element and a filling machine as described herein below.

The present application relates to a control or actuator element and in particular to a control element as described herein below, at least one cylinder compartment of which can be pressurized with a fluid pressure, i.e. with pneumatic pressure or the pressure of a hydraulic fluid, to move the actuator, which can be formed by a piston rod, for example, out of a starting position into a lift position.

On the control element claimed by the present application which is realized in the form of a pneumatic or hydraulic piston-cylinder drive or actuator, the at least one stroke limiter can be adjusted in a motorized manner by an adjustment, for example by an electrical stepper motor, whereby the adjustment can be controlled by means of an incremental encoder and/or controlled in a closed-loop control circuit.

The realization taught by the present application makes it possible to adjust an individual control element, and/or a plurality of control elements individually or in groups, in a short period of time by means of a central control system, so that the lifting movements generated by the control elements are optimally adjusted to the respective application, for example with the use of control elements for the actuation of the filling valves of a filling machine to the machine-related parameters, such as, for example, the temperature of the liquid being bottled, the ambient temperature and/or parameters related to the liquid being bottled, such as for example viscosity and foaming action.

The realization claimed by the present application also makes it possible to quickly and easily convert a plant or machine with a plurality of control elements, for example a filling machine to different operating methods, for example in the event of a change of product or the liquid being bottled.

It is also possible to perform an automatic adjustment or tracking of the stroke limiters or to adjust or track the stroke limiters in response to a command as a function of the process parameters measured during a work process, for example during a filling process.

The above-discussed embodiments of the present invention will be described further hereinbelow. When the word “invention” or “embodiment of the invention” is used in this specification, the word “invention” or “embodiment of the invention” includes “inventions” or “embodiments of the invention”, that is the plural of “invention” or “embodiment of the invention”. By stating “invention” or “embodiment of the invention”, the Applicant does not in any way admit that the present application does not include more than one patentably and non-obviously distinct invention, and maintains that this application may include more than one patentably and non-obviously distinct invention. The Applicant hereby asserts that the disclosure of this application may include more than one invention, and, in the event that there is more than one invention, that these inventions may be patentable and non-obvious one with respect to the other.

### BRIEF DESCRIPTION OF THE DRAWINGS

Developments of the present application are disclosed in the subclaims. The embodiments are explained in greater detail below with reference to one exemplary embodiment which is illustrated in the accompanying figures, in which:

FIG. 1A is a schematic illustration of a container filling plant in accordance with one possible embodiment;

FIG. 1 is a partial illustration of the rotor of a filling machine that employs the rotary construction for filling bottles or similar containers in the vicinity of a filling station;

FIG. 2 is a simplified illustration and in cross section of a filling valve of the filling machine illustrated in FIG. 1;

FIG. 3 is a simplified illustration and in cross section of a control element as claimed by the present application;

FIG. 4 shows the opening and closing device in a partially opened position;

FIG. 5 shows the opening and closing device in a substantially fully opened position;

FIG. 6 shows the control element after the first short stroke motion corresponding to the partially opened position shown in FIG. 4; and

FIG. 7 shows the control element after the second long stroke motion corresponding to the substantially fully opened position shown in FIG. 5.

### DESCRIPTION OF EMBODIMENT OR EMBODIMENTS

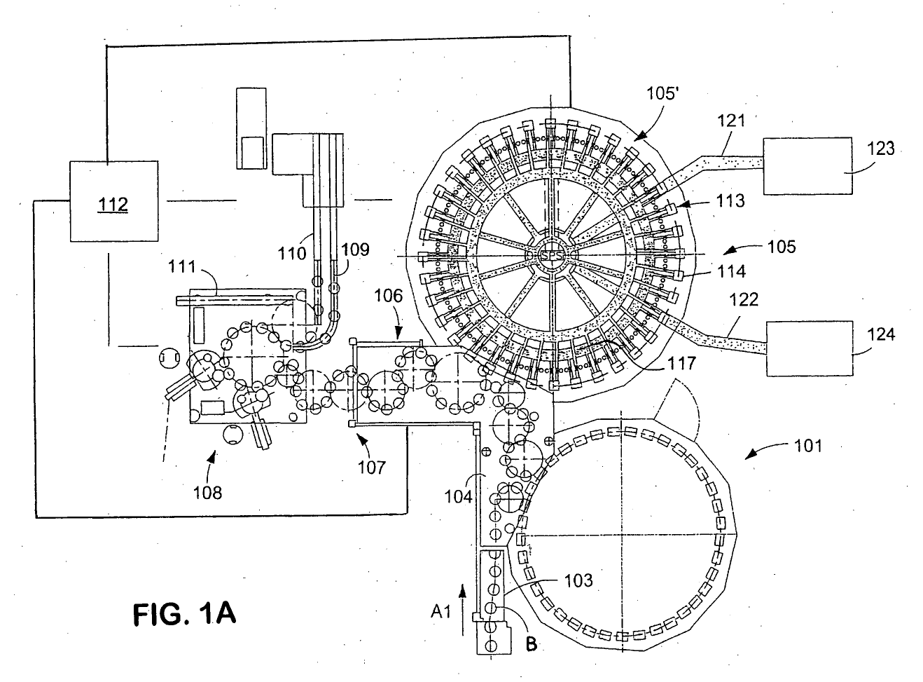

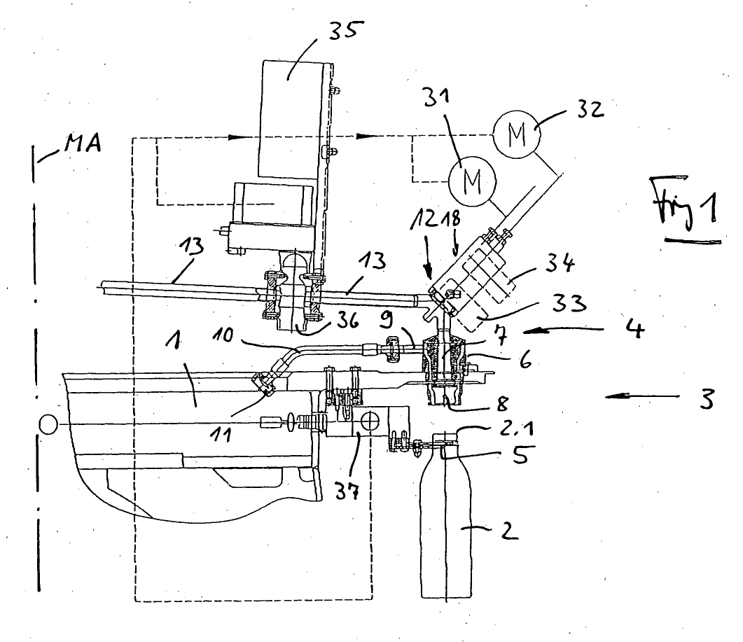

FIG. 1A shows schematically the main components of one possible embodiment example of a system for filling containers, specifically, a beverage bottling plant for filling bottles B with at least one liquid beverage, in accordance with at least one possible embodiment, in which system or plant could possibly be utilized at least one aspect, or several aspects, of the embodiments disclosed herein.

FIG. 1A shows a rinsing arrangement or rinsing station 101, to which the containers, namely bottles B, are fed in the direction of travel as indicated by the arrow A1, by a first conveyer arrangement 103, which can be a linear conveyor or a combination of a linear conveyor and a starwheel. Downstream of the rinsing arrangement or rinsing station 101, in the direction of travel as indicated by the arrow A1, the rinsed bottles B are transported to a beverage filling machine 105 by a second conveyer arrangement 104 that is formed, for example, by one or more starwheels that introduce bottles B into the beverage filling machine 105.

The beverage filling machine 105 shown is of a revolving or rotary design, with a rotor 105′, which revolves around a central, vertical machine axis. The rotor 105′ is designed to receive and hold the bottles B for filling at a plurality of filling positions 113 located about the periphery of the rotor 105′. At each of the filling positions 103 is located a filling arrangement 114 having at least one filling device, element, apparatus, or valve. The filling arrangements 114 are designed to introduce a predetermined volume or amount of liquid beverage into the interior of the bottles B to a predetermined or desired level.

The filling arrangements 114 receive the liquid beverage material from a toroidal or annular vessel 117, in which a supply of liquid beverage material is stored under pressure by a gas. The toroidal vessel 117 is a component, for example, of the revolving rotor 105′. The toroidal vessel 117 can be connected by means of a rotary coupling or a coupling that permits rotation. The toroidal vessel 117 is also connected to at least one external reservoir or supply of liquid beverage material by a conduit or supply line. In the embodiment shown in FIG. 1A, there are two external supply reservoirs 123 and 124, each of which is configured to store either the same liquid beverage product or different products. These reservoirs 123, 124 are connected to the toroidal or annular vessel 117 by corresponding supply lines, conduits, or arrangements 121 and 122. The external supply reservoirs 123, 124 could be in the form of simple storage tanks, or in the form of liquid beverage product mixers, in at least one possible embodiment.

As well as the more typical filling machines having one toroidal vessel, it is possible that in at least one possible embodiment there could be a second toroidal or annular vessel which contains a second product. In this case, each filling arrangement 114 could be connected by separate connections to each of the two toroidal vessels and have two individually-controllable fluid or control valves, so that in each bottle B, the first product or the second product can be filled by means of an appropriate control of the filling product or fluid valves.

Downstream of the beverage filling machine 105, in the direction of travel of the bottles B, there can be a beverage bottle closing arrangement or closing station 106 which closes or caps the bottles B. The beverage bottle closing arrangement or closing station 106 can be connected by a third conveyer arrangement 107 to a beverage bottle labeling arrangement or labeling station 108. The third conveyor arrangement may be formed, for example, by a plurality of starwheels, or may also include a linear conveyor device.

In the illustrated embodiment, the beverage bottle labeling arrangement or labeling station 108 has at least one labeling unit, device, or module, for applying labels to bottles B. In the embodiment shown, the labeling arrangement 108 has three output conveyer arrangement: a first output conveyer arrangement 109, a second output conveyer arrangement 110, and a third output conveyer arrangement 111, all of which convey filled, closed, and labeled bottles B to different locations.

The first output conveyer arrangement 109, in the embodiment shown, is designed to convey bottles B that are filled with a first type of liquid beverage supplied by, for example, the supply reservoir 123. The second output conveyer arrangement 110, in the embodiment shown, is designed to convey bottles B that are filled with a second type of liquid beverage supplied by, for example, the supply reservoir 124. The third output conveyer arrangement 111, in the embodiment shown, is designed to convey incorrectly labeled bottles B. To further explain, the labeling arrangement 108 can comprise at least one beverage bottle inspection or monitoring device that inspects or monitors the location of labels on the bottles B to determine if the labels have been correctly placed or aligned on the bottles B. The third output conveyer arrangement 111 removes any bottles B which have been incorrectly labeled as determined by the inspecting device.

The beverage bottling plant can be controlled by a central control arrangement 112, which could be, for example, computerized control system that monitors and controls the operation of the various stations and mechanisms of the beverage bottling plant.

In the figures, 1 is a rotor that can be driven in rotation around a vertical machine axis MA, and is part of a filling machine for the filling of bottles 2 or similar containers with a substance being bottled, for example a liquid or viscous substance. On the rotor 1, in the manner described by the prior art, there are a plurality of filling stations 3 provided at uniform angular intervals around the machine axis MA, each of which comprises a filling element 4 and a bottle or container carrier 5 that is located underneath the filling element in the vertical direction. In the illustrated exemplary embodiment, the bottle or container carrier is realized so that it grips the bottle 2 to be filled from behind, on a collar or shoulder that is provided in the vicinity of the bottle mouth 2.1, so that the bottle 2 is held suspended on the bottle carrier 5.

The filling element 4 comprises essentially a housing 6 in which, in the exemplary embodiment, a vertical liquid channel 7 is realized, which on its lower end forms a dispensing opening 8, by means of which the liquid being bottled flows into the respective bottle 2 during the filling process. In the housing 6, there is also a return gas channel 9, which is in communication via a line 10 with a channel 11, which is provided on the rotor 1 for all the filling elements 4 or for a group of such filling elements in common. The upper end of the liquid channel 7 is in communication via a filling or liquid valve 12 with a channel or a line 13, by means of which the liquid being bottled is delivered during the filling process from a reservoir or bowl (not shown), which can be provided, for example, on the rotor 1. Each filling station 3 is further realized so that during the filling process, the bottle 2 is in sealed contact with its bottle mouth 2.1 against the filling element 4. For this purpose, the bottle carrier 5 and/or the filling element 4 can be raised and lowered in a controlled fashion, in a manner that will be known to a technician skilled in the art.

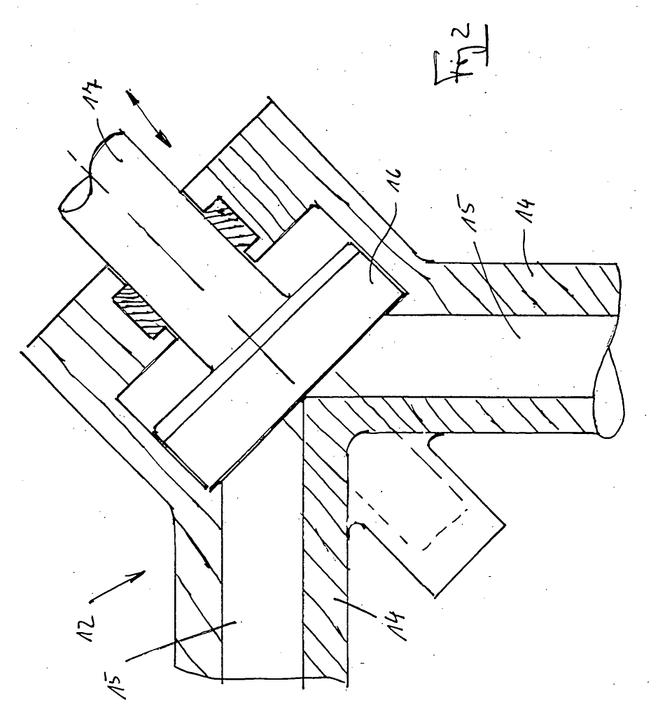

As shown schematically in FIG. 2, the filling valve 12, which is associated independently with each filling station 3, forms a liquid channel 15 in a housing 14, which channel is in communication on one hand with the line 13 and on the other hand with the liquid channel 7 of the associated filling element 4.

In the fluid channel 15, a valve body 16 is provided which, in the illustrated exemplary embodiment, can be moved from the closed position illustrated in FIG. 2 in which it blocks the liquid channel 15 into a first open position with a smaller opening or flow cross section for the filling valve 12, and into a second opening position with a larger opening or flow cross section for the filling valve 12. The valve body 16 is provided on the end of a piston rod 17 that is extended in a sealed fashion out of the liquid channel 15 and is a component of a fluid-actuator or of a fluid-piston-cylinder system or actuator device 18, for example of a pneumatic actuator device.

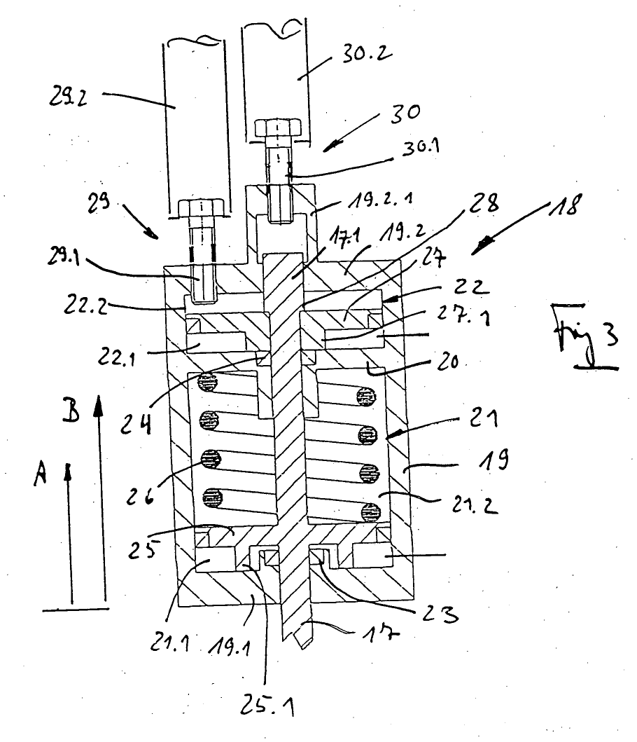

In the illustrated exemplary embodiment, the actuator device 18 comprises a cylinder housing 19 which is flange-mounted in a suitable manner on the housing 14 of the filling valve 12, and which is divided by an internal partition 20 into two cylinder compartments 21 and 22 that are oriented equiaxially with the longitudinal axis of the piston rod or actuator 17. The piston rod 17 is extended in a sealed manner through the lower end wall 19.1 of the cylinder housing 19, i.e. the end wall 19.1 next to the housing 14, and through the partition 20, in each case using a seal 23 and 24 respectively. Additionally, a piston 25 is fixed in position on the piston rod 17 in the lower cylinder compartment 21 in FIG. 3, and divides said cylinder space 21 into a lower cylinder compartment 21.1 in FIG. 3 that is farther from the partition 20 and a cylinder compartment 21.2 that is next to the partition wall 20. The cylinder compartment 21.2 contains a compression spring 26 which with its one end is braced against the partition wall 20 and with its other end against the piston 25, and thereby biases the piston rod 17 into a starting position which, when the control element 18 is used to actuate the filling valve 12 or the valve body 16, corresponds to the closed position of the filling valve 12. This starting position of the piston rod 17 in the illustrated exemplary embodiment is defined by the fact that the piston 25 is in contact by means of a ring-shaped projection 25.1 that surrounds the seal 23 and its seat against the interior surface of the cylinder compartment 21.1.

While the piston 25 is firmly connected with the piston rod 17, in the cylinder compartment 22 there is an additional piston 27 which is guided on the piston rod 17 so that it can move axially and divides the cylinder compartment into a lower cylinder compartment 22.1 that is next to the partition wall 20 and into an upper cylinder compartment 22.2, which in the illustrated exemplary embodiment is closed by the upper end wall 19.2 of the cylinder housing 19. The piston rod is guided so that it can move axially by a segment 17.1 that has an enlarged cross section in the upper end wall 19.2. At the transition to the segment 17.1, the piston rod 17 forms a collar or shoulder or ring-shaped stop 28 for the side of the piston 27 that faces the cylinder compartment 22.2. In the illustrated exemplary embodiment, the realization is designed so that when the piston rod 17 is in the starting position, the collar or stop 28 presses against the piston 27 and the piston is thereby in contact against the partition wall 20 by means of a ring-shaped projection 27.1 that encircles the piston rod 17.

On the upper end wall 19.2, there are two stroke limiters that restrict the lifting movement of the piston rod 17 and of the piston 27, namely the stroke limiter 29 that interacts with the piston 27 and the piston stop 30 that interacts with the upper end of the piston rod 17 and with the end of the segment 17.1 that is located there. The two stroke limiters can both be adjusted axially, i.e. in an axial direction parallel to the axis of the piston rod 17 individually and in a motor-driven fashion, and specifically whereby the stroke limiter 29 is driven by the actuator motor 31 and the stroke limiter 30 by the actuator motor 32.

In the illustrated exemplary embodiment, the stroke limiters 29 and 30 are each formed by a screw that is guided in a threaded portion of the end wall 19.2 or in an extension 19.2.1 provided in that location, each of which is connected in a driven connection by means of a shaft 29.2 and 30.2 respectively with the respective actuator motor.

The cylinder compartment 21.1 can be pressurized with compressed air by means of an electrically actuated control valve 33 and the cylinder compartment 22.1 by means of an electrically controlled control valve 34, so that when the control valve 34 is activated and the cylinder compartment 22.1 is pressurized with compressed air, the piston rod 17 is moved against the action of the compression spring 26 from its starting position by means of a first, shorter stroke A into a first stroke position, which is defined by the fact that the piston 27 comes into contact against the stroke limiter 29.

When the control valve 33 is activated and the cylinder compartment 21.1 is pressurized with compressed air, the piston rod 17 with the piston 25 is moved against the action of the compression spring 26 in a second, larger stroke B out of the starting position into a second stroke position, which is defined by the fact that the upper end of the piston rod 17 formed by the segment 17.1 comes into contact against the stroke limiter 30. As a result of the adjustment of the stroke limiters 29 and 30 by means of the adjustment motors 31 and 32, the magnitude of the strokes A and B can be set individually and/or adjusted to the requirements of current operations.

In the illustrated exemplary embodiment, the adjustment motors 31 and 32 are electrical actuator motors, for example electrical stepper motors with incremental encoders, so that it is possible to achieve a very precise adjustment of the stroke limiters 29 and 30 and in particular also to effect a closed-loop regulation of their position.

If the control element 18 are used for the actuation of the filling valves 12, the first stroke position (after Stroke A) corresponds to a partly opened filling valve 12 and the second stroke (after Stroke B) to the fully opened filling valve 12.

On the filling machine illustrated in FIG. 1, the filling valves 12 and/or their control elements are controlled by a central machine control system and/or by distributed control units 35 that are provided on the rotor 1, which can be provided separately for each filling station and/or in common for a group of filling stations 3, and in general, for example, so that whenever the filling station 3 in question has reached a specified position of the rotational movement of the rotor 1 and the bottle 2 to be filled is in sealed contact against the filling element 4, the filling valve 12 in question is opened, and specifically, for example, so that the piston rod 17 of the respective valve body 16 is moved into the first stroke position for a slow filling by the activation of the control valve 34, and thus the valve body 16 is moved into the first opening position, and that then, for a fast filling, by activating the control valve 33, the piston rod 17 and thus the valve body 16 are moved into the second stroke position or into the second opening position.

On the basis of the quantity of liquid being bottled that flows to the respective bottle 2 during the filling process, which is measured by a flow meter 36 that is located in the line 13 and/or on the basis of the increase in the weight of the respective bottle 2 during the filling process as measured by a weighing device 37, the closing of the filling valve 12 is initiated by means of the control unit 35, for example. This closing in turn occurs in stages such that when the control valve 34 is activated, the control valve 33 is deactivated, so that when the cylinder compartment 21.1 is unpressurized but the cylinder compartment 22.1 remains pressurized, the piston rod 17 can be retracted from the second stroke position into the first stroke position, and the filling valve 12 is thereby partly closed. The filling process is then ended by also deactivating the control valve 34, so that when the cylinder compartment 22.1 is unpressurized, the piston rod 17 is moved by the action of the compression spring 26 into its starting position and thus the valve body 16 is moved into the closed position.

The stroke limiters 29 and 30 can be adjusted, for example, by means of the control device 35 or a machine control system (computer) that is on a higher control level than the respective control device 35, and in particular, for example, as a function of the liquid being bottled, so that the graduated opening and/or closing of the filling valves 12 or of the opening cross section of these valves can be adjusted optimally in the first opening position as well as in the second opening position to the respective fluid being bottled and its characteristics, although they can also be adjusted to changing external conditions of the bottling process, for example to a changing product temperature or ambient temperature. Machine parameters such as manufacturing tolerances, wear and aging can be taken into consideration by adjusting the stroke limiters 29 and 39.

The stroke limiters 29 and 30 can be set separately or individually for each filling station 3 or for each control element 18, but they can also be set in groups for a plurality of control elements 18, simultaneously, quickly and easily by means of the external machine control system and/or by means of the distributed control units 35.

It is also possible to realize the machine control system or the distributed control units 35 so that in response to a command or current requirements, and as a function of the bottling parameters measured during the filling process such as flow velocity, the temperature of the liquid being bottled, the ambient temperature, bottling pressure etc., which bottling parameters are measured by corresponding sensors, for example by the inductive flow meter 36, by the weighing device 37, by thermometers and pressure gauges (not shown), etc., there is an automatic tracking or re-adjustment of the stroke limiters 29 and 30, for example with a program that is stored in the central machine control system and/or in the distributed control units 35 to achieve a uniform and consistent bottling process or bottling level and to achieve an optimal output of the filling machine.

The present application has been described above on the basis of one single exemplary embodiment. It goes without saying that numerous modifications and variants can be made without thereby going beyond the teaching on which the present application is based. For example, it has been assumed above that the respective control element 18 is pneumatically controlled. Theoretically a hydraulic actuation of this element is also possible.

If the control elements 18 are used to control filling valves on filling machines, it is of course not necessary for these filling valves to have the configuration described with reference to FIGS. 1 and 2. Other constructive realizations of the filling valves are also possible.

The control elements 18 can also be used especially for the control of filling valves on filling elements so that, one stroke limiter can also be used to define the closed position of the respective filling valve or the position of the piston rod of the control element that corresponds to this closed position, at least when the filling machine is in operation. In the realization of the control element 18 illustrated in FIG. 3, then, with the cylinder compartment 22.1 constantly pressurized, the position of the piston rod 17 that corresponds to the closed position of the filling valve 12 is determined by the stroke limiter 29, while the stroke limiter 30 defines the stroke position of the piston rod 17 that corresponds to the open position of the filling valve. This realization has the advantage that when the respective filling valve is closed, the closing movement of the valve body 16 is decelerated by the pneumatic pressure in the cylinder compartment 22.1, and the valve body 16 comes into contact with the valve seat gently, thereby eliminating or significantly reducing wear of the filling valves 12.

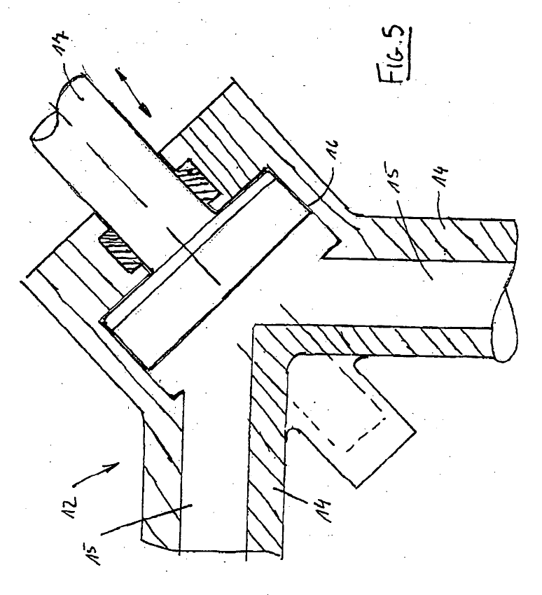

In another possible embodiment, the flow valve 12 comprises a housing 14 that houses the liquid channel 15, the opening and closing device 16, and the bottom portion of the piston rod 17 that is connected to the opening and closing device 16. The housing has an inlet portion 50 and an outlet portion 52, as shown in FIG. 5. The opening and closing device 16 is shown in FIG. 5 in the fully opened position. The fully opened position permits the fast filling of bottles. A junction 54 is positioned between the inlet portion 50 and the outlet portion 52.

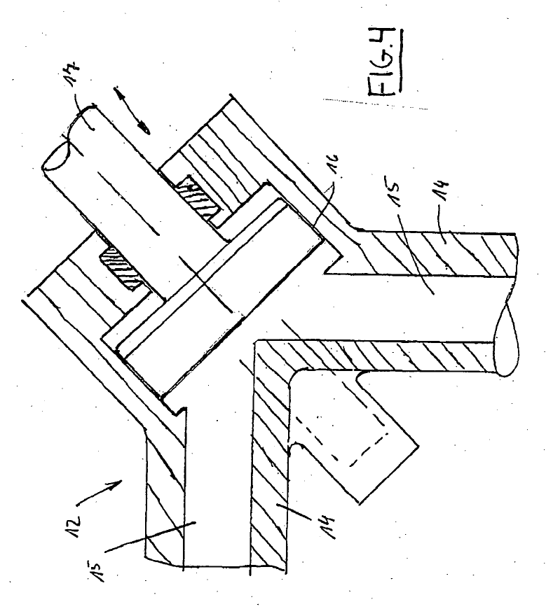

During filling, the opening and closing device 16 is moved from the rest position shown in FIG. 2 to a partially opened position shown in FIG. 4. The partially opened position permits a slow filling of bottles. To move the opening and closing device 16 into the partially opened position, the actuator device 18 is activated to pull the piston rod 17, and thus the opening and closing device 16, out of the path of the liquid channel 15.

As shown in FIG. 3, the actuator device 18 comprises the upper part of the piston 17, which piston 17 is enclosed by a housing 19. The enlarged upper end of the piston 17.1 has a shoulder portion 28 that keeps the enlarged upper portion above, or on the top of, the piston 27. Within the housing 19, a partition 20 separates the inside of the housing into a lower cylinder compartment 21 and an upper cylinder compartment 22. A first lower piston 25 is fixed in position on the piston rod 17 and is located in the lower cylinder compartment 21. A second upper piston 27 is slidably connected to the piston rod 17, and is located in the upper cylinder compartment 22. A compression spring 26 is located between the partition wall 20 and the first bottom piston. The compression spring 26 is designed to apply a bias force to the piston rod 17 to maintain a rest, or closed, position of the opening and closing device 16, and also to move the piston rod 17 back into the closed position upon a bottle being filled.

A first stroke limiter 29 and a second stroke limiter 30 are located in the top end wall 19.2 of the housing 19. The first stroke limiter 29 is in a position to come into contact with the second upper piston 25. The second stroke limiter 30 is in a position to come into contact with the enlarged upper end 17.1 of the piston rod 17. The stroke limiters 29 and 30 are each formed by a screw that is guided in a threaded portion of the end wall 19.2 or in an extension 19.2.1 provided in that location, each of which is connected in a driven connection by means of a shaft 29.2 and 30.2, respectively, with actuator motors 31 and 32. The stroke limiters 29 and 30 are designed to be adjustable. Adjustments can be made individually to the stroke limiters 29 and 30 depending on the characteristics of the fluid being bottled, such as the temperature, viscosity, density, etc., of the fluid. A smooth, quick, clean filling of bottles is thus achieved, and the number of bottles that can be filled per hour is greatly increased.

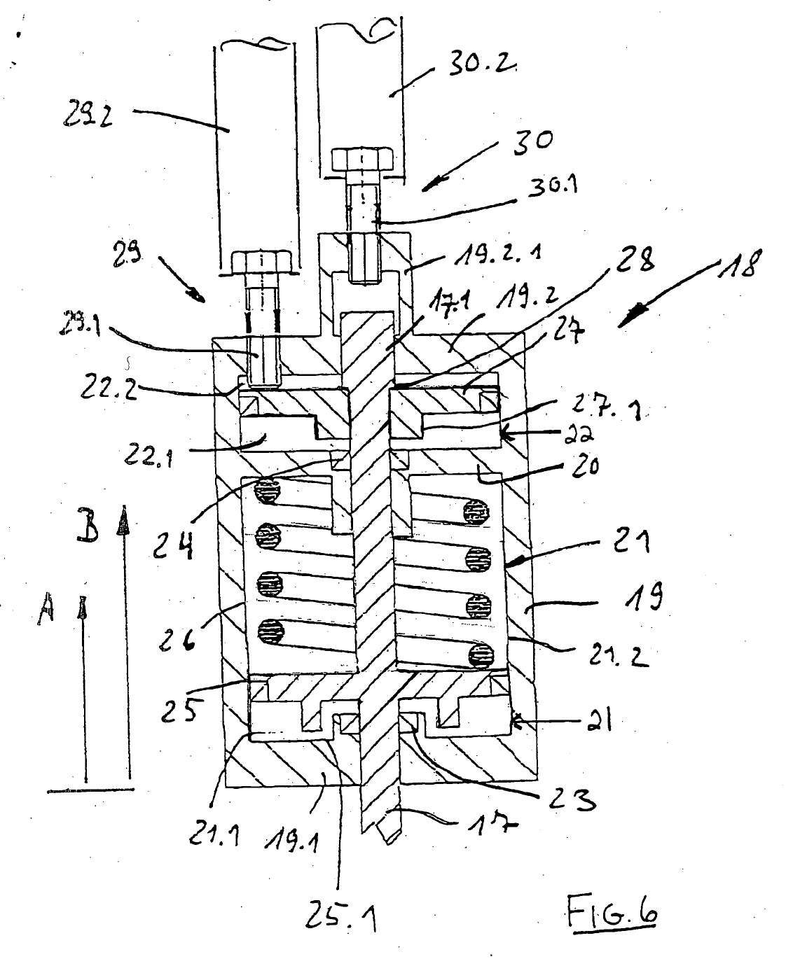

When a bottle is positioned beneath the filling device, a weighing device 37 sends a signal to the actuator motor 31. A control valve 33 then pressurizes the upper cylinder compartment 22.2, forcing the second upper piston 27 in an upward motion. As the second upper piston 27 moves upward, it pulls the piston rod 17 with it via the shoulder portion 28, and thus also pulls with it the first lower piston 25, which is in a fixed position on the piston rod 17. The second upper piston 27 comes into contact with the first stroke limiter 29, and the upward motion of the second upper piston 27, the first lower piston 25, and the piston rod 17 is stopped, as shown in FIG. 6. This short stroke motion pulls the opening and closing device 16 such that it is moved, against the bias of the compression spring 26, slightly out of the path of the liquid channel 15, as shown in FIG. 4. The liquid channel 15 is thus partially blocked, permitting a slow filling of a bottle.

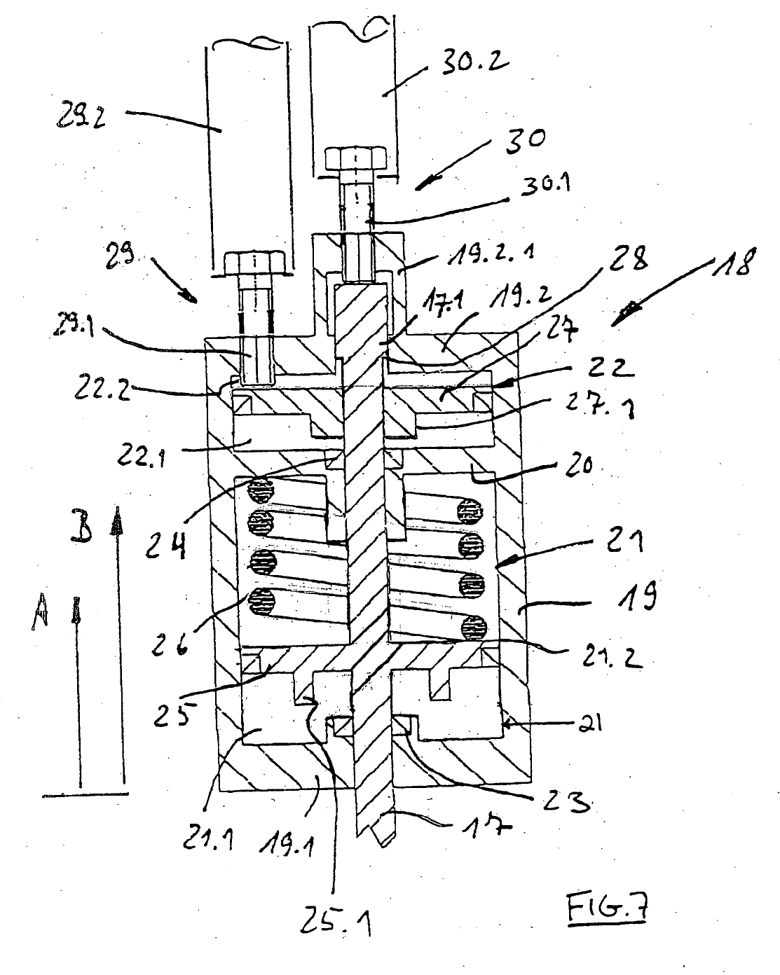

Depending on the characteristics of the liquid being bottled, the weighing device 37 sends a signal to the actuator motor 32 when a fast filling of the bottle is necessary. The control valve 34 is then activated, and the lower cylinder chamber 21.1 is pressurized, pushing the first lower piston 25, and thus the piston rod 17, in an upward motion. Since the second upper piston 27 is slidably attached to the piston rod 17 and has been stopped by the first stroke limiter 29 for slow filling, the piston rod 17 is able to slide upward through the second upper piston 27 to come into contact with the stroke limiter 30. The stroke limiter 30 stops the upward motion of the piston rod 17 and the first lower piston 25, as shown in FIG. 7. This long stroke motion pulls the opening and closing device 16 such that it is moved further out of the path of the liquid channel 15, as shown in FIG. 5. The liquid channel 15 is thus substantially fully opened, permitting a fast filling of a bottle.

Once the bottle has been filled, the weighing device 37 sends a signal to the 31 and 32 to deactivate the control valves 33 and 34. Once the signal is received by the control valves 33 and 34, the lower chamber 21.1 is depressurized and the upper chamber 22.1 is depressurized. The bias force of the compression spring 26 returns the first lower piston 25, the second upper piston 27, the piston rod 17, and thus the opening and closing device 16, to the closed, rest position.

In one possible embodiment, the upper chamber 22.1 and the lower chamber 21.1 could be depressurized simultaneously, taking the opening and closing device 16 from a fast filling position to a fully closed position. In another possible embodiment, the lower chamber 21.1 could be depressurized first, taking the opening and closing device 16 from a fast filling position to a slow filling position. The upper cylinder container 22.1 could then be depressurized, taking the closing device 16 from a slow filling position to the closed, rest position. The sequence of depressurization could be dependent on the type, temperature, viscosity, or density of the fluid being bottled.

The present application relates to a control element with at least one piston that can be moved axially in at least one cylinder and defines at least one cylinder compartment that can be pressurized with the pressure of a fluid, and with at least one adjustable stroke limiter that limits the stroke of the piston and/or of a actuator that is effectively connected with the piston, a motor-driven adjustment drive is provided for said at least one stroke limiter.

One feature or aspect of an embodiment is believed at the time of the filing of this patent application to possibly reside broadly in a control element with at least one piston that can be moved axially in at least one cylinder and defines at least one cylinder compartment that can be pressurized with the pressure of a fluid, and with at least one adjustable stroke limiter that limits the stroke of the piston and/or of a actuator that is effectively connected with the piston, characterized in that a motor-driven adjustment drive is provided for the at least one stroke limiter.

Another feature or aspect of an embodiment is believed at the time of the filing of this patent application to possibly reside broadly in a control element, characterized in that the adjustment drive is an electric motor, for example a stepper motor.

Yet another feature or aspect of an embodiment is believed at the time of the filing of this patent application to possibly reside broadly in a control element, characterized in that the adjustment drive of the at least one strike limiter has an incremental encoder.

Still another feature or aspect of an embodiment is believed at the time of the filing of this patent application to possibly reside broadly in a control element, characterized in that the actuator is a piston rod that interacts with the at least one piston.

A further feature or aspect of an embodiment is believed at the time of the filing of this patent application to possibly reside broadly in a control element, characterized in that the at least one stroke limiter determines the limit position of the at least one piston and/or actuator when the cylinder compartment is pressurized.

Another feature or aspect of an embodiment is believed at the time of the filing of this patent application to possibly reside broadly in a control element, characterized in that the at least one stroke limiter determines the limit position of the at least one piston and/or of the actuator when the cylinder compartment is unpressurized.

Yet another feature or aspect of an embodiment is believed at the time of the filing of this patent application to possibly reside broadly in a control element, characterized in that the at least one stroke limiter can be adjusted parallel to the axis of movement of the at least one piston.

Still another feature or aspect of an embodiment is believed at the time of the filing of this patent application to possibly reside broadly in a control element, characterized in that the at least one stroke limiter is formed by a threaded pin that can be engaged in a threaded portion of the cylinder.

A further feature or aspect of an embodiment is believed at the time of the filing of this patent application to possibly reside broadly in a control element, characterized in that the at least one stroke limiter interacts with a surface of the at least one piston that faces away from the cylinder compartment and is offset radially, for example, with respect to the axis of the piston.

Another feature or aspect of an embodiment is believed at the time of the filing of this patent application to possibly reside broadly in a control element, characterized in that the at least one stroke limiter interacts with one end of the actuator or of the piston rod.

Yet another feature or aspect of an embodiment is believed at the time of the filing of this patent application to possibly reside broadly in a control element, characterized in that the at least one piston and the actuator that is effectively connected with said piston are biased by spring means in a starting position, preferably in the starting position that corresponds to the unpressurized cylinder compartment.

Still another feature or aspect of an embodiment is believed at the time of the filing of this patent application to possibly reside broadly in a control element, characterized in that the at least one piston is located so that it can move axially on the piston rod, and that on the piston and/or on the piston rod, coupling and/or driver means are provided which, during the movement of the piston in a first stroke direction, effect a non-positive connection between the piston and the piston rod, and make possible a movement of the piston without being accompanied by the piston rod in a second, opposite stroke direction.

A further feature or aspect of an embodiment is believed at the time of the filing of this patent application to possibly reside broadly in a control element, characterized in that for a stepped movement of the actuator or of the piston rod out of the starting position, in a first, e.g. smaller stroke into a first stroke position and in a second, e.g. longer stroke into a second stroke position, two pistons are provided, with at least one cylinder compartment that can be pressurized with the fluid pressure, and that at least one individually adjustable stroke limiter is provided for each piston.

Another feature or aspect of an embodiment is believed at the time of the filing of this patent application to possibly reside broadly in a control element, characterized in that the at least two pistons are provided on a common actuator or a common piston rod, and that at least one piston is located on the actuator so that during a movement out of a starting position into a stroke position, it drives the actuator, i.e. it is in a driving connection with the latter, although it can be moved out of the stroke position into the starting position without being accompanied by the actuator.

Yet another feature or aspect of an embodiment is believed at the time of the filing of this patent application to possibly reside broadly in a control element, characterized in that a first piston for the longer stroke is in a fixed connection with the common actuator or with the common piston rod, that a second piston acts in a drive connection on the common actuator or on the common piston rod only during the shorter stroke, and that a first adjustable stroke limiter interacts with the piston rod and a second adjustable stroke limiter with the second piston.

Still another feature or aspect of an embodiment is believed at the time of the filing of this patent application to possibly reside broadly in a control element, characterized in that the cylinder compartments can each be pressurized in a controlled manner by means of a respective control valve with fluid under pressure, for example compressed air or hydraulic medium.

A further feature or aspect of an embodiment is believed at the time of the filing of this patent application to possibly reside broadly in a control element, characterized by its realization in the form of a control element for the actuation of a filling valve of a filling machine for the filling of bottles or similar containers with a liquid to be bottled.

Another feature or aspect of an embodiment is believed at the time of the filing of this patent application to possibly reside broadly in a filling machine employing a rotary construction with a plurality of filling stations formed on a periphery of a rotor, each with a filling element and a filling valve that is actuated by a control element, characterized in that the control element is realized as described in one of the preceding claims.

Yet another feature or aspect of an embodiment is believed at the time of the filing of this patent application to possibly reside broadly in a filling machine, characterized in that the starting position of the actuator or of the piston rod of the control element corresponds to the closed position of the filling valve and the at least one stroke position of the actuator or of the piston rod corresponds to an open position of the filling valve.

Still another feature or aspect of an embodiment is believed at the time of the filing of this patent application to possibly reside broadly in a filling machine, characterized in that when there are two different stroke positions of the actuator of the control element, the one stroke position corresponds to a first opening position of the fill valve, for example with a reduced opening cross section, and the second stroke position of the actuator of the control element corresponds to a second opening position of the filling valve, for example with a larger opening cross section.

A further feature or aspect of an embodiment is believed at the time of the filing of this patent application to possibly reside broadly in a filling machine, characterized by the fact that the stroke limiters of the individual control elements can be adjusted by means of a central machine control system, preferably individually, for example as a function of the machine parameters such as, for example, manufacturing tolerances, wear, aging and/or as a function of external parameters, such as, for example, product temperature, ambient temperature etc. and/or as a function of parameters or properties of the liquid being bottled, such as, for example, viscosity, foaming tendency etc.

Another feature or aspect of an embodiment is believed at the time of the filing of this patent application to possibly reside broadly in a filling machine, characterized in that the stroke limiters can be adjusted by the central machine control system and/or by distributed control devices as a function of filling parameters that are measured automatically or on request during the filling process, such as for example flow speed, temperature and filling pressure, according to at least one program that is stored in the central control system and/or in the distributed control devices.

Yet another feature or aspect of an embodiment is believed at the time of the filing of this patent application to possibly reside broadly in a filling machine, characterized in that at each filling position, a flow meter for the measurement of the quantity of liquid dispensed into the bottle and/or a weighing cell for the measurement of the increase in the weight of the respective container during filling are provided.

The components disclosed in the various publications, disclosed or incorporated by reference herein, may possibly be used in possible embodiments of the present invention, as well as equivalents thereof.

The purpose of the statements about the technical field is generally to enable the Patent and Trademark Office and the public to determine quickly, from a cursory inspection, the nature of this patent application. The description of the technical field is believed, at the time of the filing of this patent application, to adequately describe the technical field of this patent application. However, the description of the technical field may not be completely applicable to the claims as originally filed in this patent application, as amended during prosecution of this patent application, and as ultimately allowed in any patent issuing from this patent application. Therefore, any statements made relating to the technical field are not intended to limit the claims in any manner and should not be interpreted as limiting the claims in any manner.

Some examples of bottling systems, which may be used or adapted for use in at least one possible embodiment of the present may be found in the following U.S. Patents assigned to the Assignee herein, namely: U.S. Pat. No. 4,911,285; U.S. Pat. No. 4,944,830; U.S. Pat. No. 4,950,350; U.S. Pat. No. 4,976,803; U.S. Pat. No. 4,981,547; U.S. Pat. No. 5,004,518; U.S. Pat. No. 5,017,261; U.S. Pat. No. 5,062,917; U.S. Pat. No. 5,062,918; U.S. Pat. No. 5,075,123; U.S. Pat. No. 5,078,826; U.S. Pat. No. 5,087,317; U.S. Pat. No. 5,110,402; U.S. Pat. No. 5,129,984; U.S. Pat. No. 5,167,755; U.S. Pat. No. 5,174,851; U.S. Pat. No. 5,185,053; U.S. Pat. No. 5,217,538; U.S. Pat. No. 5,227,005; U.S. Pat. No. 5,413,153; U.S. Pat. No. 5,558,138; U.S. Pat. No. 5,634,500; U.S. Pat. No. 5,713,403; U.S. Pat. No. 6,276,113; U.S. Pat. No. 6,213,169; U.S. Pat. No. 6,189,578; U.S. Pat. No. 6,192,946; U.S. Pat. No. 6,374,575; U.S. Pat. No. 6,365,054; U.S. Pat. No. 6,619,016; U.S. Pat. No. 6,474,368; U.S. Pat. No. 6,494,238; U.S. Pat. No. 6,470,922; and U.S. Pat. No. 6,463,964.

The appended drawings in their entirety, including all dimensions, proportions and/or shapes in at least one embodiment of the invention, are accurate and are hereby included by reference into this specification.

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

Some examples of filling machines that utilize electronic control devices to control various portions of a filling or bottling process and that may possibly be utilized or possibly adapted for use in at least one possible embodiment of the present application may possibly be found in the following U.S. patents: U.S. Pat. No. 4,821,921 issued to Cartwright et al. on Apr. 18, 1989; U.S. Pat. No. 5,056,511 issued to Ronge on Oct. 15, 1991; U.S. Pat. No. 5,273,082 issued to Paasche et al. on Dec. 28, 1993; and U.S. Pat. No. 5,301,488 issued to Ruhl et al. on Apr. 12, 1994.

All, or substantially all, of the components and methods of the various embodiments may be used with at least one embodiment or all of the embodiments, if more than one embodiment is described herein.

The purpose of the statements about the object or objects is generally to enable the Patent and Trademark Office and the public to determine quickly, from a cursory inspection, the nature of this patent application. The description of the object or objects is believed, at the time of the filing of this patent application, to adequately describe the object or objects of this patent application. However, the description of the object or objects may not be completely applicable to the claims as originally filed in this patent application, as amended during prosecution of this patent application, and as ultimately allowed in any patent issuing from this patent application. Therefore, any statements made relating to the object or objects are not intended to limit the claims in any manner and should not be interpreted as limiting the claims in any manner.

Some examples of open-loop control systems that may possibly be utilized or possibly adapted for use in at least one possible embodiment of the present application may possibly be found in the following U.S. patents: U.S. Pat. No. 5,770,934 issued to Theile on Jun. 23, 1998; U.S. Pat. No. 5,210,473 issued to Backstrand on May 11, 1993; U.S. Pat. No. 5,320,186 issued to Strosser et al. on Jun. 14, 1994; and U.S. Pat. No. 5,369,342 issued to Rudzewicz et al. on Nov. 29, 1994.

All of the patents, patent applications and publications recited herein, and in the Declaration attached hereto, are hereby incorporated by reference as if set forth in their entirety herein.

Some examples of closed-loop control circuits that may possibly be utilized or possibly adapted for use in at least one possible embodiment of the present application may possibly be found in the following U.S. patents: U.S. Pat. No. 5,770,934 issued to Theile on Jun. 23, 1998; U.S. Pat. No. 5,189,605 issued to Zuehlke et al. on Feb. 23, 1993; U.S. Pat. No. 5,223,072 issued to Brockman et al. on Jun. 29, 1993; and U.S. Pat. No. 5,252,901, issued to inventors Ozawa et al. on. Oct. 12, 1993.

The summary is believed, at the time of the filing of this patent application, to adequately summarize this patent application. However, portions or all of the information contained in the summary may not be completely applicable to the claims as originally filed in this patent application, as amended during prosecution of this patent application, and as ultimately allowed in any patent issuing from this patent application. Therefore, any statements made relating to the summary are not intended to limit the claims in any manner and should not be interpreted as limiting the claims in any manner.

Some examples of stepping motors that may possibly be utilized or possibly adapted for use in at least one possible embodiment of the present application may possibly be found in the following U.S. patents: U.S. Pat. No. 6,348,774 issued to Andersen et al. on Feb. 19, 2002; U.S. Pat. No. 6,373,209 issued to Gerber et al. on Apr. 16, 2002; U.S. Pat. No. 6,424,061 issued to Fukuda et al. on Jul. 23, 2002; U.S. Pat. No. 6,509,663 issued to Aoun on Jan. 21, 2003; U.S. Pat. No. 6,548,923 to Ohnishi et al. on Apr. 15, 2003; and U.S. Pat. No. 6,661,193 issued to Tsai on Dec. 9, 2003.

It will be understood that the examples of patents, published patent applications, and other documents which are included in this application and which are referred to in paragraphs which state “Some examples of . . . which may possibly be used in at least one possible embodiment of the present application . . . ” may possibly not be used or useable in any one or more embodiments of the application.

The sentence immediately above relates to patents, published patent applications and other documents either incorporated by reference or not incorporated by reference.

Some examples of servo-motors that may possibly be utilized or possibly adapted for use in at least one possible embodiment of the present application may possibly be found in the following U.S. patents: U.S. Pat. No. 4,050,434 issued to Zbikowski et al. on Sep. 27, 1977; U.S. Pat. No. 4,365,538 issued to Andoh on Dec. 28, 1982; U.S. Pat. No. 4,550,626 issued to Brouter on Nov. 5, 1985; U.S. Pat. No. 4,760,699 issued to Jacobsen et al. on Aug. 2, 1988; U.S. Pat. No. 5,076,568 issued to de Jong et al. on Dec. 31, 1991; and U.S. Pat. No. 6,025 issued to Yasui on Feb. 15, 2000.

The corresponding foreign patent publication applications, namely, Federal Republic of Germany Patent Application No. 10 2005 011 659.0, filed on Mar. 8, 2005, having inventors Roland Topf and Matthias Bestmann, and DE-OS 10 2005 011 659.0 and DE-PS 10 2005 011 659.0, are hereby incorporated by reference as if set forth in their entirety herein for the purpose of correcting and explaining any possible misinterpretations of the English translation thereof. In addition, the published equivalents of the above corresponding foreign and international patent publication applications, and other equivalents or corresponding applications, if any, in corresponding cases in the Federal Republic of Germany and elsewhere, and the references and documents cited in any of the documents cited herein, such as the patents, patent applications and publications, are hereby incorporated by reference as if set forth in their entirety herein.

The following patent publications were cited in an Office Action for the corresponding German Application, and are hereby incorporated by reference as of set forth in their entirety herein, as follows: JP 62 00 9008A; DE 100 58 250 A1; and DE 1964 084 U.

Some examples of synchronous motors which may possibly be utilized or adapted for use in at least one possible embodiment may possibly be found in the following U.S. Patents: U.S. Pat. No. 6,713,899, entitled “Linear synchronous motor;” U.S. Pat. No. 6,486,581, entitled “Interior permanent magnet synchronous motor;” U.S. Pat. No. 6,424,114, entitled “Synchronous motor;” U.S. Pat. No. 6,388,353, entitled “Elongated permanent magnet synchronous motor;” U.S. Pat. No. 6,329,728, entitled “Cylinder-type linear synchronous motor;” U.S. Pat. No. 6,025,659, entitled “Synchronous motor with movable part having permanent magnets;” U.S. Pat. No. 5,936,322, entitled “Permanent-magnet type synchronous motor;” and U.S. Pat. No. 5,448,123, entitled “Electric synchronous motor.”

All of the references and documents, cited in any of the documents cited herein, are hereby incorporated by reference as if set forth in their entirety herein. All of the documents cited herein, referred to in the immediately preceding sentence, include all of the patents, patent applications and publications cited anywhere in the present application.

Some examples of computer systems that may possibly be utilized or possibly adapted for use in at least one possible embodiment of the present application may possibly be found in the following U.S. Patents: U.S. Pat. No. 5,416,480 issued to Roach et al. on May 16, 1995; U.S. Pat. No. 5,479,355 issued to Hyduke on Dec. 26, 1995; U.S. Pat. No. 5,481,730 issued to Brown et al. on Jan. 2, 1996; U.S. Pat. No. 5,805,094 issued to Roach et al. on Sep. 8, 1998; U.S. Pat. No. 5,881,227 issued to Atkinson et al. on Mar. 9, 1999; and U.S. Pat. No. 6,072,462 issued to Moshovich on Jun. 6, 2000.

The description of the embodiment or embodiments is believed, at the time of the filing of this patent application, to adequately describe the embodiment or embodiments of this patent application. However, portions of the description of the embodiment or embodiments may not be completely applicable to the claims as originally filed in this patent application, as amended during prosecution of this patent application, and as ultimately allowed in any patent issuing from this patent application. Therefore, any statements made relating to the embodiment or embodiments are not intended to limit the claims in any manner and should not be interpreted as limiting the claims in any manner.

Some examples of control valve apparatus that may possibly be utilized or possibly adapted for use in at least one possible embodiment of the present application may possibly be found in the following U.S. Patents: U.S. Pat. No. 5,406,975 issued to Nakamichi et al. on Apr. 18, 1995; U.S. Pat. No. 5,503,184 issued to Reinartz et al. on Apr. 2, 1996; U.S. Pat. No. 5,706,849 issued to Uchida et al. on Jan. 13, 1998; U.S. Pat. No. 5,975,115 issued to Schwegler et al. on Nov. 2, 1999; U.S. Pat. No. 6,142,445 issued to Kawaguchi et al. on Nov. 7, 2000; and U.S. Pat. No. 6,145,538 issued to Park on Nov. 14, 2000.

The details in the patents, patent applications and publications may be considered to be incorporable, at applicant's option, into the claims during prosecution as further limitations in the claims to patentably distinguish any amended claims from any applied prior art.

Some examples of electric control valves that may possibly be utilized or possibly adapted for use in at least one possible embodiment of the present application may possibly be found in the following U.S. Patents: U.S. Pat. No. 4,431,160 issued to Burt et al. on Feb. 14, 1984; and U.S. Pat. No. 4,609,176 issued to Powers on Sep. 2, 1986.

The purpose of the title of this patent application is generally to enable the Patent and Trademark Office and the public to determine quickly, from a cursory inspection, the nature of this patent application. The title is believed, at the time of the filing of this patent application, to adequately reflect the general nature of this patent application. However, the title may not be completely applicable to the technical field, the object or objects, the summary, the description of the embodiment or embodiments, and the claims as originally filed in this patent application, as amended during prosecution of this patent application, and as ultimately allowed in any patent issuing from this patent application. Therefore, the title is not intended to limit the claims in any manner and should not be interpreted as limiting the claims in any manner.

Some examples of pneumatic arrangements that may possibly be utilized or possibly adapted for use in at least one possible embodiment of the present application may possibly be found in the following U.S. Patents: U.S. Pat. No. 6,609,767 issued to Mortenson et al. on Aug. 26, 2003; U.S. Pat. No. 6,632,072 issued to Lipscomb et al. on Oct. 14, 2003; U.S. Pat. No. 6,637,838 issued to Watanabe on Oct. 28, 2003; U.S. Pat. No. 6,659,693 issued to Perkins et al. on Dec. 9, 2003; U.S. Pat. No. 6,668,848 issued to Ladler et al. on Dec. 30, 2003; and U.S. Pat. No. 6,676,229 issued to Marra et al. on Jan. 13, 2004.

The abstract of the disclosure is submitted herewith as required by 37 C.F.R. §1.72(b). As stated in 37 C.F.R. §1.72(b):
A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims.
   Therefore, any statements made relating to the abstract are not intended to limit the claims in any manner and should not be interpreted as limiting the claims in any manner.

Some examples of filling machines that utilize electronic control devices to control various portions of a filling or bottling process and that may possibly be utilized or possibly adapted for use in at least one possible embodiment of the present application may possibly be found in the following U.S. patents: U.S. Pat. No. 4,821,921 issued to Cartwright et al. on Apr. 18, 1989; U.S. Pat. No. 5,056,511 issued to Ronge on Oct. 15, 1991; U.S. Pat. No. 5,273,082 issued to Paasche et al. on Dec. 28, 1993; and U.S. Pat. No. 5,301,488 issued to Ruhl et al. on Apr. 12, 1994.

Some examples of pneumatic valves which may possibly be utilized or adapted for use in at least one possible embodiment may possibly be found in the following U.S. Patents: U.S. Pat. No. 6,772,791, entitled “Directly operated pneumatic valve having an air assist return;” U.S. Pat. No. 6,729,346, entitled “Pneumatic valve;” U.S. Pat. No. 6,676,107, entitled “Control element, especially a pneumatic valve;” U.S. Pat. No. 6,550,416, entitled “Pneumatic valve device;” U.S. Pat. No. 6,543,481, entitled “Pilot operated pneumatic valve;” U.S. Pat. No. 6,488,050, entitled “Pneumatic valve assembly;” U.S. Pat. No. 6,089,251, entitled “Pneumatic valve;” U.S. Pat. No. 4,526,341, entitled “Pneumatic shut-off valve;” U.S. Pat. No. 4,515,183, entitled “Pneumatic control valve;” and U.S. Pat. No. 4,480,663, entitled “Pneumatic relay valve.”

Some examples of hydraulic valves which may possibly be utilized or adapted for use in at least one possible embodiment may possibly be found in the following U.S. Patents: U.S. Pat. No. 6,712,090, entitled “Hydraulic valve;” U.S. Pat. No. 6,745,557, entitled “Hydraulic valve arrangement;” U.S. Pat. No. 6,578,819, entitled “Hydraulic valve;” U.S. Pat. No. 6,505,645, entitled “Multiple hydraulic valve assembly with a monolithic block; U.S. Pat. No. 6,499,505, entitled “Hydraulic valve arrangement;” U.S. Pat. No. 6,427,721, entitled “Hydraulic valve arrangement with locking function;” U.S. Pat. No. 6,412,392, entitled “Hydraulic valve for a hydraulic consumer of a vehicle;” U.S. Pat. No. 6,397,891, entitled “Hydraulic valve, in particular, adjustable pressure control valve;” U.S. Pat. No. 6,349,743, entitled “High-pressure hydraulic valve;” and U.S. Pat. No. 6,305,418, entitled “Hydraulic valve.”

Some examples of electric valves which may possibly be utilized or adapted for use in at least one possible embodiment may possibly be found in the following U.S. Patents: U.S. Pat. No. 5,941,502, entitled “Electric valve assembly and method of making same;” U.S. Pat. No. 5,161,776, entitled “High speed electric valve;” U.S. Pat. No. 4,770,389, entitled “Electric valve device;” U.S. Pat. No. 4,699,167, entitled “Electric valve;” U.S. Pat. No. 4,681,298, entitled “Slidable electric valve device having a spring;” U.S. Pat. No. 4,580,761, entitled “Electric valve device having a rotatable core;” and U.S. Pat. No. 4,498,491, entitled “Thermo-electric valve.”

The embodiments of the invention described herein above in the context of the preferred embodiments are not to be taken as limiting the embodiments of the invention to all of the provided details thereof, since modifications and variations thereof may be made without departing from the spirit and scope of the embodiments of the invention.

### AT LEAST PARTIAL LIST OF TERMS

1 Rotor
2 Bottle
2.1 Bottle mouth
3 Filling position
4 Filling element
5 Bottle carrier
6 Housing of the filling element
7 Liquid channel
8 Dispensing opening
9 Return gas channel
10 Return gas line
11 Return gas channel in the rotor 1
12 Filling valve
13 Line for liquid being bottled
14 Housing of the filling valve 12
15 Liquid channel
16 Valve body
17 Piston rod
17.1 Segment of the piston rod 17
18 Control element
19 Cylinder housing
19.1, 19.2 End side of the cylinder housing
19.2.1 Projection on the end wall 19.2
20 Partition
21, 22 Cylinder space
21.1, 21.2 Cylinder compartment
22.1, 22.2 Cylinder compartment
23, 24 Seal
25 Piston
25.1 Projection of the piston 25
26 Compression spring
27 Piston
27.1 Projection of the piston 27
28 Collar, shoulder, or stop
29, 30 Stroke limiter
29.1, 30.1 Screw
29.2, 30.2 Shaft
31, 32 Adjustment motor
33, 34 Electric control valve
35 Distributed control unit
36 Flow meter
37 Weighing device or weighing cell
MA Vertical machine axis
A, B Stroke of the piston rod 17

What is claimed is:

1. In a beverage bottling plant, a filling machine being configured and disposed to fill bottles with a liquid beverage, said filling machine comprising:
a first conveyor arrangement being configured and disposed to convey bottles to be filled to said bottle filling machine;
a rotor;
a rotatable vertical machine column;
said rotor being connected to said vertical machine column to permit rotation of said rotor about said vertical machine column;
a plurality of bottle filling elements for filling bottles with liquid beverage material being disposed on the periphery of said rotor;
each of said plurality of bottle filling elements comprising a bottle carrier being configured and disposed to receive and hold beverage bottles to be filled;
each of said plurality of bottle filling elements being configured and disposed to dispense liquid beverage material into bottles to be filled;
at least one liquid reservoir being configured to hold a supply of liquid beverage material;
a liquid supply line being configured and disposed to connect said at least one liquid reservoir to said bottle filling machine to supply liquid beverage material to said bottle filling machine;
at least one sensor being configured to sense the amount of liquid beverage being dispensed into bottles disposed beneath said filling elements;
a second conveying arrangement being configured and disposed to move bottles out of said bottle filling machine;
a flow valve being disposed in said liquid supply line;
said flow valve comprising a housing;
said housing comprising an inlet portion and an outlet portion;
a liquid channel being disposed in said housing and being configured to permit the flow of liquid therethrough;
said flow valve comprising:
an opening and closing device being disposed at a juncture between said inlet portion and said outlet portion;
said opening and closing device being configured and disposed to be moved, to permit the fast flow of liquid from said inlet portion to said outlet portion during filling, to permit the slow flow of liquid from said inlet portion to said outlet portion during filling, and to block the flow of liquid through said flow valve upon a bottle being filled;
an actuator device being configured to actuate said opening and closing device, said actuator device comprising:
a piston rod being connected to and extending perpendicularly away from said opening and closing device, and comprising an enlarged upper segment;
a housing being configured and disposed to house said piston rod;
a first lower piston being disposed within said housing and about said piston rod;
a first lower cylinder compartment being disposed between said first lower piston and said housing;
a second upper piston being disposed within said housing and about said piston rod;
a second upper cylinder compartment being disposed between said second upper piston and said housing;
said first lower piston being disposed substantially closer to said opening and closing device than said second upper piston;
a compression spring being disposed between said first lower piston and said second upper piston;
said compression spring being configured and disposed to apply a bias force to said piston rod to hold said opening and closing device in a closed rest position to block the flow of liquid through said flow valve;
a first adjustable stroke limiter being disposed in the upper side of said housing above said second upper piston;
a second adjustable stroke limiter being disposed in the upper side of said housing above said piston rod, and being disposed substantially parallel to said first adjustable stroke limiter;
a motor driven adjustment drive being configured to individually adjust said first adjustable stroke limiter and said second adjustable stroke limiter to compensate for variances in the liquid being bottled, such as for temperature and thickness of the liquid;
a first control valve being disposed outside of said housing;
a second control valve being disposed outside of said housing;
said first control valve being configured to pressurize said second upper cylinder compartment upon receiving a signal from said at least one sensor, and to move said piston rod, said first lower piston, and said second upper piston upwardly in a short stroke motion toward said first adjustable stroke limiter;
said first adjustable stroke limiter being configured and disposed to come into contact with said second upper piston and to stop the upward short stroke motion of said piston rod;
said upward short stroke motion of said piston rod being configured to move said opening and closing device from its closed rest position against the bias of said compression spring, and into a partially opened position, permitting a slow fill of a bottle being disposed beneath said filling device;
said second control valve being configured to pressurize said first lower cylinder compartment upon receiving a signal from said at least one sensor, and to move said piston rod and said first lower piston upwardly in a long stroke motion toward said second adjustable stroke limiter;
said second adjustable stroke limiter being configured and disposed to come into contact with said enlarged upper segment of said piston rod and to stop the upward long stroke motion of said piston rod;
said upward long stroke motion of said piston rod being configured to move said opening and closing device from its partially opened position and into a fully opened position, permitting a fast fill of a bottle being disposed beneath said filling device; and
said first control valve and said second control valve being configured to be deactivated to move said piston rod and said opening and closing device, back into a closed rest position upon a bottle being filled.

2. The filling machine according to claim 1, wherein:
said adjustment drive is an electric motor, for example a stepper motor;
said adjustment drive of said first adjustable stroke limiter and said second adjustable stroke limiter has an incremental encoder;
said first adjustable stroke limiter and said second adjustable stroke limiter determine the limit position of said first lower piston and said second upper piston and/or said piston rod when said first lower cylinder compartment and said second upper cylinder compartment are pressurized;
said first adjustable stroke limiter and said second adjustable stroke limiter determine the limit position of said first lower piston and said second upper piston and/or said piston rod when said first lower cylinder compartment and said second upper cylinder compartment are depressurized;
said first adjustable stroke limiter and said second adjustable stroke limiter can be adjusted parallel to the axis of movement of said first lower piston and said second upper piston;
said first adjustable stroke limiter and said second adjustable stroke limiter are formed by a threaded pin that can be engaged in a threaded portion of the housing;
said first adjustable stroke limiter interacts with a surface of said second upper piston that faces away from the second upper cylinder compartment and is offset radially, for example, with respect to the axis of said second upper piston;
said first lower piston and said second upper piston are both disposed on said piston rod, and that said second upper piston is located on the piston rod so that during a movement out of a starting position into a stroke position, it drives said piston rod, i.e. it is in a driving connection with said piston rod, although it can be moved out of the stroke position into the starting position without being accompanied by said piston rod;
said first lower piston for said long stroke motion is in a fixed connection with said piston rod, and that said second upper piston acts in a drive connection on said piston rod only during said short stroke motion, and that said first adjustable stroke limiter interacts with said piston rod and said second adjustable stroke limiter interacts with the said second upper piston;
said first lower cylinder compartment and said second upper cylinder compartment can each be pressurized in a controlled manner by said first control valve and said second control valve with fluid under pressure, for example compressed air or hydraulic medium;
when there are two different stroke positions of said piston rod of said actuator device, the first stroke position corresponds to a first opening position of said flow valve, for example with a reduced opening cross section, and the second stroke position of the piston rod of the actuator device corresponds to a second opening position of said flow valve, for example with a larger opening cross section;
said first and second adjustable stroke limiters can be adjusted by means of a central machine control system, preferably individually, for example as a function of the machine parameters such as, for example, manufacturing tolerances, wear, aging and/or as a function of external parameters, such as, for example, product temperature, ambient temperature etc. and/or as a function of parameters or properties of the liquid being bottled, such as, for example, viscosity, foaming tendency etc.;
said filling machine comprises distributed control devices being configured to adjust said first and second adjustable stroke limiters;
said first and second adjustable stroke limiters can be adjusted by the central machine control system and/or by distributed control devices as a function of filling parameters that are measured automatically or on request during the filling process, such as for example flow speed, temperature and filling pressure, according to at least one program that is stored in the central control system and/or in said distributed control devices; and
said filling machine comprises a flow meter for the measurement of the quantity of liquid dispensed into a bottle and/or a weighing cell for the measurement of the increase in the weight of the respective bottle at each filling position during filling.

3. In a bottling plant, a filling machine being configured and disposed to fill bottles with a liquid, said filling machine comprising:
a first conveyor arrangement being configured and disposed to convey bottles to be filled to said bottle filling machine;
a plurality of bottle filling stations for filling bottles with liquid;
each of said plurality of bottle filling stations comprising a bottle carrier being configured and disposed to receive and hold bottles to be filled;
each of said plurality of bottle filling stations being configured and disposed to dispense liquid into bottles to be filled;
at least one liquid supply conduit being configured and disposed to supply liquid to said plurality of filling stations;
a second conveying arrangement being configured and disposed to move bottles out of said bottle filling machine;
a flow valve being disposed in said at least one liquid supply conduit;
said flow valve comprising a housing;
said housing comprising an inlet portion and an outlet portion;
a liquid channel being disposed in said housing and being configured to permit the flow of liquid therethrough;
said flow valve comprising:
an opening and closing device being disposed at a juncture between said inlet portion and said outlet portion and being configured and disposed to be moveable, to permit the flow of liquid from said inlet portion to said outlet portion during filling, and to block the flow of liquid through said flow valve upon a bottle being filled;
an actuator device being configured to actuate said opening and closing device to open and close said opening and closing device;
at least two adjustable stroke limiters each being configured to limit the stroke of the opening and closing device to a determined stroke;
a first of said at least two adjustable stroke limiters being configured to provide a first flow rate to a bottle;
a second of said at least two adjustable stroke limiters being configured to provide a second flow rate to a bottle;
said first flow rate and said second flow rate being substantially different;
each of said adjustable stroke limiters having an adjustment drive being configured to adjust the stroke of said opening and closing device to optimize the flow of liquid into a bottle at a determined time during the filling cycle of a bottle; and
a stroke limit controller being configured to adjust the stroke of each stroke limiter to compensate for changing conditions of the liquid and thus to minimize the time of the filling of the bottle.

4. The filling machine according to claim 3, wherein:
said adjustment drive is an electric motor, for example a stepper motor; and
said adjustment drive of said at least two strike limiters has an incremental encoder.

5. The filling machine according to claim 4, wherein:
said actuator device comprises at least one piston;
said actuator device comprises at least one cylinder compartment being configured and disposed to be pressurized and depressurized;
said actuator device is a piston rod that interacts with said at least one piston; and
said at least two stroke limiters determines the limit position of said at least one piston and/or said actuator device when said at least one cylinder compartment is pressurized.

6. The filling machine according to claim 5, wherein:
said at least two stroke limiters determine the limit position of said at least one piston and/or of said actuator device when said at least one cylinder compartment is unpressurized; and
said at least two stroke limiters can be adjusted parallel to the axis of movement of said at least one piston.

7. The filling machine according to claim 6, wherein:
said actuator device comprises a housing;
said at least two stroke limiters are formed by a threaded pin that can be engaged in a threaded portion of said housing;
the first of said at least two stroke limiters interacts with a surface of said at least one piston that faces away from said at least one cylinder compartment and is offset radially, for example, with respect to the axis of said at least one piston; and
the second of said at least two stroke limiters interacts with one end of said actuator device or piston rod.

8. The filling machine according to claim 7, wherein:
said at least one piston and said actuator device that is effectively connected with said piston are biased by spring means in a starting position, preferably in the starting position that corresponds to said at least one cylinder compartment when it is unpressurized;
said actuator device comprises at least two pistons;
a first of said at least two pistons is located so that it can move axially on said piston rod, and that on said piston and/or on said piston rod, coupling and/or driver means are provided which, during the movement of the first of said at least two pistons in a first stroke direction, effect a non-positive connection between the first of said at least two pistons and said piston rod, and make possible a movement of the first of said at least two pistons without being accompanied by said piston rod in a second, opposite stroke direction; and
for a stepped movement of said actuator device or of said piston rod out of the starting position, in a first, e.g. smaller stroke into a first stroke position and in a second, e.g. longer stroke into a second stroke position, said at least two pistons are provided, with said at least one cylinder compartment that can be pressurized with fluid pressure, and that said at least one individually adjustable stroke limiter is provided for each of said at least two pistons.

9. The filling machine according to claim 8, wherein:
said at least two pistons are both provided on said piston rod, and that the first of said at least two pistons is located on said piston rod so that during a movement out of a starting position into a stroke position, it drives said piston rod, i.e. it is in a driving connection with said piston rod, although it can be moved out of the stroke position into the starting position without being accompanied by said piston rod;
the second of said at least two pistons for the longer stroke is in a fixed connection with said piston rod, that the first of said at least two pistons acts in a drive connection on said piston rod only during the shorter stroke, and that the second of said at least two adjustable stroke limiters interacts with said piston rod and the first of said at least two adjustable stroke limiters interacts with the first of said at least two pistons; and
said at least one cylinder compartment can be pressurized in a controlled manner by means of a corresponding control valve with fluid under pressure, for example compressed air or hydraulic medium.

10. The filling machine according to claim 9, wherein:
the starting position of said actuator device or of said piston rod corresponds to the closed position of said flow valve and the at least one stroke position of said actuator or of said piston rod corresponds to an open position of said flow valve;
there are two different stroke positions of said actuator device, wherein the first stroke position corresponds to a first opening position of said flow valve, for example with a reduced opening cross section, and the second stroke position of said actuator device corresponds to a second opening position of said flow valve, for example with a larger opening cross section.

11. The filling machine according to claim 10, wherein:
said at least two stroke limiters of the individual actuator devices can be adjusted by means of a central machine control system, preferably individually, for example as a function of the machine parameters such as, for example, manufacturing tolerances, wear, aging and/or as a function of external parameters, such as, for example, product temperature, ambient temperature etc. and/or as a function of parameters or properties of the liquid being bottled, such as, for example, viscosity, foaming tendency etc.;
said at least two stroke limiters can be adjusted by the central machine control system and/or by distributed control devices as a function of filling parameters that are measured automatically or on request during the filling process, such as for example flow speed, temperature and filling pressure, according to at least one program that is stored in the central control system and/or in the distributed control devices; and
each bottle filling station comprises a flow meter for the measurement of the quantity of liquid dispensed into a bottle and/or a weighing cell for the measurement of the increase in the weight of the corresponding bottle during filling.

12. A method of filling a bottle with a liquid in a bottle filling machine in a bottle filling plant, said bottle filling machine comprising: a first conveyor arrangement being configured and disposed to convey bottles to be filled to said bottle filling machine; a plurality of bottle filling stations for filling bottles with liquid; each of said plurality of bottle filling stations comprising a bottle carrier being configured and disposed to receive and hold bottles to be filled; each of said plurality of bottle filling stations being configured and disposed to dispense liquid into bottles to be filled; at least one liquid supply conduit being configured and disposed to supply liquid to said plurality of filling stations; a second conveying arrangement being configured and disposed to move bottles out of said bottle filling machine; a flow valve being disposed in said at least one liquid supply conduit; said flow valve comprising a housing; said housing comprising an inlet portion and an outlet portion; a liquid channel being disposed in said housing and being configured to permit the flow of liquid therethrough; said flow valve comprising: an opening and closing device being disposed at a juncture between said inlet portion and said outlet portion and being configured and disposed to be moveable, to permit the flow of liquid from said inlet portion to said outlet portion during filling, and to block the flow of liquid through said flow valve upon a bottle being filled; an actuator device being configured to actuate said opening and closing device to open and close said opening and closing device; at least two adjustable stroke limiters each being configured to limit the stroke of the opening and closing device to a determined stroke; a first of said at least two adjustable stroke limiters being configured to provide a first flow rate to a bottle; a second of said at least two adjustable stroke limiters being configured to provide a second flow rate to a bottle; said first flow rate and said second flow rate being substantially different; each of said adjustable stroke limiters having an adjustment drive being configured to adjust the stroke of said opening and closing device to optimize the flow of liquid into a bottle at a determined time during the filling cycle of a bottle; and a stroke limit controller being configured to adjust the stroke of each stroke limiter to compensate for changing conditions of the liquid and thus to minimize the time of the filling of the bottle, said method comprising the steps of:
adjusting the first of said least two stroke limiters with said adjustment drive to a first position to compensate for variances in the liquid or for different characteristics of the liquid to be bottled during a bottling run;
activating the actuator device to move said opening and closing device upwardly toward the first of said at least two stroke limiters;
stopping the upward movement of said actuator device with the first of said at least two stroke limiters to permit a slow filling of a bottle;
adjusting the second of said least two stroke limiters with said adjustment drive to a second position to compensate for variances in the liquid or for different characteristics of the liquid to be bottled during a bottling run;
activating the actuator device to move said opening and closing device upwardly toward the second of said at least two stroke limiters;
stopping the upward movement of said actuator device with the second of said at least two stroke limiters to permit a fast filling of a bottle; and
deactivating said actuator device upon a bottle being filled to move said opening and closing device to its starting position to block the flow of liquid into a bottle.

13. The method of filling a bottle according to claim 12, wherein:
said adjustment drive is an electric motor, for example a stepper motor; and
said adjustment drive of said at least two strike limiters has an incremental encoder.

14. The method of filling a bottle according to claim 13, wherein:
said actuator device comprises at least one piston;
said actuator device comprises at least one cylinder compartment being configured and disposed to be pressurized and depressurized;
said actuator device is a piston rod that interacts with said at least one piston; and
said at least two stroke limiters determines the limit position of said at least one piston and/or said actuator device when said at least one cylinder compartment is pressurized.

15. The method of filling a bottle according to claim 14, wherein:
said at least two stroke limiters determine the limit position of said at least one piston and/or of said actuator device when said at least one cylinder compartment is unpressurized; and
said at least two stroke limiters can be adjusted parallel to the axis of movement of said at least one piston.

16. The method of filling a bottle according to claim 15, wherein:
said actuator device comprises a housing;
said at least two stroke limiters are formed by a threaded pin that can be engaged in a threaded portion of said housing;
the first of said at least two stroke limiters interacts with a surface of said at least one piston that faces away from said at least one cylinder compartment and is offset radially, for example, with respect to the axis of said at least one piston; and
the second of said at least two stroke limiters interacts with one end of said actuator device or piston rod.

17. The method of filling a bottle according to claim 16, wherein:
said at least one piston and said actuator device that is effectively connected with said piston are biased by spring means in a starting position, preferably in the starting position that corresponds to said at least one cylinder compartment when it is unpressurized;
said actuator device comprises at least two pistons;
a first of said at least two pistons is located so that it can move axially on said piston rod, and that on said piston and/or on said piston rod, coupling and/or driver means are provided which, during the movement of the first of said at least two pistons in a first stroke direction, effect a non-positive connection between the first of said at least two pistons and said piston rod, and make possible a movement of the first of said at least two pistons without being accompanied by said piston rod in a second, opposite stroke direction; and
for a stepped movement of said actuator device or of said piston rod out of the starting position, in a first, e.g. smaller stroke into a first stroke position and in a second, e.g. longer stroke into a second stroke position, said at least two pistons are provided, with said at least one cylinder compartment that can be pressurized with fluid pressure, and that said at least one individually adjustable stroke limiter is provided for each of said at least two pistons.

18. The method of filling a bottle according to claim 17, wherein:
said at least two pistons are both provided on said piston rod, and that the first of said at least two pistons is located on said piston rod so that during a movement out of a starting position into a stroke position, it drives said piston rod, i.e. it is in a driving connection with said piston rod, although it can be moved out of the stroke position into the starting position without being accompanied by said piston rod;
the second of said at least two pistons for the longer stroke is in a fixed connection with said piston rod, that the first of said at least two pistons acts in a drive connection on said piston rod only during the shorter stroke, and that the second of said at least two adjustable stroke limiters interacts with said piston rod and the first of said at least two adjustable stroke limiters interacts with the first of said at least two pistons; and
said at least one cylinder compartment can be pressurized in a controlled manner by means of a corresponding control valve with fluid under pressure, for example compressed air or hydraulic medium.

19. The method of filling a bottle according to claim 18, wherein:
the starting position of said actuator device or of said piston rod corresponds to the closed position of said flow valve and the at least one stroke position of said actuator or of said piston rod corresponds to an open position of said flow valve;
there are two different stroke positions of said actuator device, wherein the first stroke position corresponds to a first opening position of said flow valve, for example with a reduced opening cross section, and the second stroke position of said actuator device corresponds to a second opening position of said flow valve, for example with a larger opening cross section.

20. The method of filling a bottle according to claim 19, wherein:
said at least two stroke limiters of the individual actuator devices can be adjusted by means of a central machine control system, preferably individually, for example as a function of the machine parameters such as, for example, manufacturing tolerances, wear, aging and/or as a function of external parameters, such as, for example, product temperature, ambient temperature etc. and/or as a function of parameters or properties of the liquid being bottled, such as, for example, viscosity, foaming tendency etc.;
said at least two stroke limiters can be adjusted by the central machine control system and/or by distributed control devices as a function of filling parameters that are measured automatically or on request during the filling process, such as for example flow speed, temperature and filling pressure, according to at least one program that is stored in the central control system and/or in the distributed control devices; and
each bottle filling station comprises a flow meter for the measurement of the quantity of liquid dispensed into a bottle and/or a weighing cell for the measurement of the increase in the weight of the corresponding bottle during filling.
